(19) United States
(12) Patent Application Publication
(10) Pub. No.: US 2006/0259255 A1
(43) Pub. Date: Nov. 16, 2006

(54) METHOD OF VISUALIZING POWER SYSTEM QUANTITIES USING A CONFIGURABLE SOFTWARE VISUALIZATION TOOL

(76) Inventors: James Christopher Anderson, Pullman, WA (US); William Bruce Scallorn, Moscow, ID (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/460,233

(22) Filed: Jul. 26, 2006

Related U.S. Application Data
(63) Continuation-in-part of application No. 11/399,285, filed on Apr. 5, 2006.
(60) Provisional application No. 60/668,252, filed on Apr. 5, 2005.

(51) Int. Cl. G06F 19/00

(52) U.S. Cl. 702/64

(57) ABSTRACT

A system for transmitting synchronized phasors over a wide area network. The system generally includes a plurality of phasor measurement units (PMUs). Each of the PMUs are associated with a secured portion of a power system and measure power system data from the secured portion of the power system associated therewith. The power system data is associated with a time-element. A power system data concentrator is further provided in communication with the phasor measurement units such that it aggregates and time-correlates the power system data. A configurable docking visualization tool or software is provided which communicates with the PMUs and data aggregators. The configurable tool provides an end user with the ability to dock or nest pre-configured forms for optimal viewing of synchronized phasor data and different power system quantities.

### RELATED APPLICATION

This application is a continuation-in-part and claims the benefit of U.S. Non-Provisional application Ser. No. 11/399,285 filed on Apr. 5, 2006, which claims the benefit of Provisional Application No. 60/668,252, filed Apr. 5, 2005.

### BACKGROUND OF THE INVENTION

The present invention concerns the monitoring and protection of electrical power systems. More particularly, the present invention concerns a method for visualizing and monitoring power system quantities using a configurable software visualization tool.

Generally, power system control or protective devices are used for protecting, monitoring, controlling, metering and/or automating electric power systems and associated transmission lines. These power system control or protective devices may include protective relays, remote terminal units (RTUs), programmable logic controllers (PLCs), bay controllers, supervisory controlled and data acquisition (SCADA) systems, general computer systems, meters, and any other comparable devices used for protecting, monitoring, controlling, metering and/or automating electric power systems and their associated transmission lines. Some of these power system control or protective devices are further adapted to measure and/or derive synchronized phasor measurements, including but not limited to voltage/current synchronized phasor measurements. Synchronized phasor measurements are generally defined in the IEEE Standard C37.118-2006 and are otherwise referred to as synchronized phasors or synchrophasors.

Devices which measure and/or derive phasors are referred to as phasor measurement units (PMUs). PMUs may further be adapted to measure or derive synchronized phasors. PMU may further be adapted to measure and/or derive other power system values, including but not limited to frequency, voltage magnitude and angle, current magnitude and angle, change in frequency over time, digital values, analog scalar quantities and values derived from power system quantities.

One known approach for measuring synchronized phasors involves using a protective relay. U.S. Pat. No. 6,662,124, assigned to Schweitzer Engineering Laboratories, describes a protective relay for electric power systems for system-wide control and analysis and for protection. This patent is incorporated by reference herein and made a part hereof. The protective relay generally includes an acquisition circuit for obtaining voltage values and/or current values from a power line. A first sampling circuit therein samples the voltage and/or current values at selected intervals of time. A first calculation system uses the resulting samples to perform selected power system-wide control and analysis determinations. A frequency estimating circuit determines the power system frequency, wherein a second sampling circuit resamples the sampled voltage and/or current values at a rate, which is related to the power system frequency. A second calculation system using the resampled voltage and current values performs selected protection functions for the portion of the power line associated with the protective relay.

U.S. Pat. No. 6,662,124 describes yet another protective relay for electric power systems using synchronized phasors for system-wide control and analysis and for power line protection. This second embodiment protective relay includes voltage and current acquisition circuits for obtaining voltage and current values from a power line. A sampling circuit is further provided for sampling the voltage and current values at selected intervals of time, wherein the sampling is based on an absolute time value reference. A first calculation system using the sampled signals performs selected power system-wide protection, control and analysis determinations and produces synchronized voltage and current phasor values from the acquired voltage and current values. The synchronized voltage and current values are substantially independent of system frequency for protection and control functions. A second calculation system is further provided being responsive to synchronized phasor values from the protective relay and from another relay which is remote from the protective relay on the same power line. Accordingly, U.S. Pat. No. 6,662,124 describes an example of a PMU being a protective relay.

U.S. Pat. No. 6,845,333, assigned to Schweitzer Engineering Laboratories, describes a protective relay for electric power systems for system-wide control and analysis and for protection. This patent is incorporated by reference herein and made a part hereof. The protective relay generally includes an acquisition circuit for obtaining voltage values and current values, from an electric power system. A sampling circuit is further provided for sampling the voltage or current values at selected intervals of time, wherein the sampling is based on an absolute time reference. A communication system is also provided for transmitting messages containing synchronized phasor values from the protective relay to a host device.

U.S. Pat. No. 6,845,333 describes yet another protective relay using synchronized phasors for protection of electric power systems. The second embodiment protective relay includes an acquisition circuit for obtaining voltage values and current values from the power system. A sampling circuit is further provided for sampling the voltage or current values at selected intervals of time, wherein the sampling is based on an absolute time reference. A calculation system is also provided using the sampled signals to produce synchronized voltage or current phasor values. The synchronized voltage or current phasor values are further used to perform selected protection functions for the power system, wherein the synchronized voltage and current phasor values being acquired independent of power system frequency.

U.S. Pat. No. 6,845,333 describes yet another protective relay using synchronized phasors for protection of electric power systems. This third embodiment protective relay includes an acquisition circuit for obtaining voltage values and/or current values from the power system. A sampling circuit is further provided for sampling the voltage or current values at selected intervals of time, wherein the sampling is based on an absolute time reference. A calculation system is also provided using the sampled signals to produce synchronized voltage or current phasor values and then using the synchronized voltage or current phasor values to perform selected protection functions for the power system, wherein the synchronized voltage and current phasor values are acquired independent of power system frequency. The relay further includes a receiving circuit for receiving voltage or current values from another relay which is remote from the protective relay and wherein the calculation system is responsive to the voltage or current values from the protective relay and from another relay to perform selected protection functions for the power system involving the protective relay and another relay.

In this third embodiment of the U.S. Pat. No. 6,845,333 patent, synchronized phasor measurement data from a device is described to be reported in two different ways, unsolicited binary messages at specific time intervals and solicited ASCII messages at specific times. For example, two devices (intelligent electronic devices, such as protective relays) communicate with a host computer over conventional communication channels, using a conventional CRC (cyclical redundancy check) error detection method. Unsolicited binary messages from the IEDs to the host computer typically includes the IED address that is used by the host computer to determine the data source, the sample number of the data, the data acquisition time stamp with the absolute time reference, the power system estimated frequency, the phase and positive sequence voltages and currents from the power line, an indication of correct time synchronization, a confirmation that the data packet is ok, followed by general purpose bits, and lastly, an error detection code.

With solicited messages, the devices respond to a command from the host computer relative to a phasor measurement by reporting synchronized phasor measurements of meter data (magnitude and angle for the three phase currents and voltages) in the power system at specific times. Accordingly, U.S. Pat. No. 6,845,333 describes an example of a PMU being a protective relay.

Although the examples above and the embodiments described herein refer to protective relays, it is contemplated that the present invention may also be associated with any device which measures and/or derives synchronized phasors. For example, in addition to protective relays, remote terminal units (RTUs), programmable logic counters (PLCs), bay controllers, supervisory controlled and data acquisition (SCADA) systems, general computer systems, meters, IEDs and any other device used for measuring synchronized phasors may be considered PMUs.

As an indicator of the state of an electric power system, synchronized phasors must be communicated, time-correlated across the system, and compared with other synchronized phasors in order to be valuable. More specifically, a comparison of synchronized phasors provides information regarding power angles across power lines, power transfer, system stability margins, and possible system isolation.

In viewing the landscape of power grids, North America includes five different synchronous networks as shown in FIG. 1, including Eastern Interconnection, Western Interconnection, ERCOT (Texas), Mexico, and Quebec. Every connected generator in each of the power grids is synchronously tied to every other in the network. Nevertheless, within a network, generators that are synchronously tied together are generally not in phase as relative angles between generators change with load flows across the system. Therefore, it is preferable that the phase angles relative to each of the networks and within each network be displayed and communicated.

In an example of system isolation (e.g., islanding), one system within a grid may become out-of-phase with other systems within the same grid. When islanding occurs, a system becomes out of synch from a nominal frequency or out of phase. When the islanded system is later reconnected without being synchronous to the phase and frequency of the grid, severe damage or complete destruction can occur to the switchgears and generators. Therefore, it is an objective of this invention to provide a system and method for monitoring system isolation or islanding within a grid.

PMUs have been traditionally interconnected together through fiber optic cable or other physical connections. These interconnections often prove to be very costly and involve multiple high cost lines. Accordingly, it is further desired that synchronized phasors be sent across a wide-area network. Because the power system is a secured network, it is also desired to transmit synchronized phasors from the secured portion of the power system to a non-secure network. It is yet another objective of the present invention to transmit and display other power system values such as frequency, voltage magnitude and angle, current magnitude and angle, change in frequency over time, digital values, and analog scalar quantities. In this manner, an end user may easily access the power system data.

It is also desirable to align and correlate the synchronized phasors from different sites (e.g., within or between power grids). It is the object of the present invention to display and update synchronized phasors and other power system values in real time to show any relationship between different sites.

Power system values and quantities can be communicated through a network system and viewed on a terminal monitor or computer. However, effective and efficient communication of the synchronized phasors along with other power system quantities to the end user requires a flexible and customizable software visualization tool. It is the object of this invention to provide a customizable visualization software tool that allows customization of how the power system values and quantities are displayed, configured, and arranged within a docking window environment.

Another aspect of this invention is to provide the end user of the visualization tool with pre-configured visualizations. These pre-configured visualization forms present information concerning specific aspects of the electric power system such as phasor angles, phasor magnitude, frequency, rate of change of frequency, plus various digital and analog scalar values.

Fault conditions or power system events may only be apparent by viewing and correlating multiple docked visualizations that are displaying information regarding different PMUs or sycrhophasor data. To facilitate viewing this information, it is further desired to view multiple docked visualizations on one or more monitors, screens or display devices. Another aspect of the visualization software tool is that it provides a highly-configurable method of arranging visualizations for simultaneous viewing of a plurality of power system quantities. As a result, the invention allows a user to see changes in the power system state that may only be indicated by changes in a combination of different power system quantities.

It is also desirable to maintain histories and trending data associated with synchronized phasors and other power system values. This information may help in diagnosing future faults or operating conditions. It is the object of this invention to archive the data associated with synchronized phasors and other power system quantities and to configure and manage pre-configured visualization screens for real-time streaming data, archived data, or a combination of both.

These and other desired benefits of the preferred embodiments, including combinations of features thereof, of the invention will become apparent from the following description. It will be understood, however, that a process or arrangement could still appropriate the claimed invention without accomplishing each and every one of these desired benefits, including those gleaned from the following description. The appended claims, not these desired benefits, define the subject matter of the invention. Any and all benefits are derived from the multiple embodiments of the invention, not necessarily the invention in general.

### SUMMARY OF INVENTION

According to an aspect of the invention, disclosed is a system for transmitting synchronized phasors over a wide area network. The system generally includes a plurality of phasor measurement units (PMUs). Each of the PMUs are associated with a secured portion of a power system and measure power system data from the secured portion of the power system associated therewith. The power system data is associated with a time element and may be selected from a group consisting of phasors, synchronized phasors, frequency, voltage magnitude and angle, current magnitude and angle, change in frequency over time, digital values, analog scalar quantities and values derived from power system quantities.

A power system data concentrator is further provided in communication with the phasor measurement units such that it aggregates and time-correlates the power system data. A server is further provided in communication with the power system data concentrator. The server includes a program for transferring the aggregated time-correlated power system data from the secured portion of the power system to a non-secure network.

In accordance with another aspect of the invention, each of the secured portions of the power system are located in different power system grids. Accordingly, each of the phasor measurement units are associated with different power system grids.

In accordance with another aspect of the invention, the power system data is associated with a time element using a high-accuracy clock communicating with each of the phasor measurement units.

In accordance with another aspect of the invention, the non-secure network is the Internet.

In accordance with another aspect of the invention, the system further includes a firewall or a virtual private network for providing security between the secured portion of the power system and the non-secure network.

In accordance with another aspect of the invention, the program for transferring the aggregated time-correlated power system data from the secured portion of the power system to the user accessible network further comprises a buffer.

In accordance with another aspect of the invention, the server includes a program for graphically depicting the power system data. Furthermore, it is further provided that the secured portions of the power system may be graphically depicted on a map and the power system data may be graphically displayed therewith.

According to an aspect of the invention, a method for transmitting synchronized phasors over a wide area network is provided. The method generally includes the steps of measuring power system data for a secured portion of a power system; time-correlating the power system data; aggregating the time-correlated power system data; and transferring the aggregated time-correlated power system data from the secured portion of the power system to a user accessible network.

In accordance with an aspect of the invention, a configurable visualization software tool is provided for graphically depicting the power system data. Moreover, the software tool provides a plurality of pre-configured visualizations to view different power system quantities. It is further provided that the software tool is highly customizable, for example, in that multiple visualizations of the user's choosing can be displayed in one or more docked forms or windows. Additionally, the software tool provides for multiple monitor or support.

### BRIEF DESCRIPTION OF THE DRAWINGS

FIG. 1 illustrates a power grid synchronous network of North America.

FIG. 2 is a one-line schematic diagram of an electric power system in a typical metropolitan area.

FIG. 3 illustrates a phasor measurement unit (PMU) coupled with a high-accuracy clock using a communications link.

FIG. 4 illustrates an example of the data format that may be used in the phasor measurement unit of FIG. 3.

FIG. 5 depicts a configuration of a phasor measurement unit as a protective relay.

FIG. 6 illustrates an embodiment of a system and method for transmitting power system data from a secured network to a non-secure network.

FIG. 7 illustrates an embodiment of a PDC buffer storing synchronized system data to be polled by a web server.

FIG. 8 illustrates another embodiment of a system and method for transmitting power system data from a secured network to a non-secure network.

FIG. 9 illustrates yet another embodiment of a system and method for transmitting power system data from a secured network to a non-secure network.

FIG. 10 illustrates a graphical display of power system data of United States in accordance to an embodiment of the present invention.

FIG. 11 illustrates a global visualization in accordance to an embodiment of the present invention.

FIG. 12 depicts another embodiment of a network system with a plurality of PMUs, PDCs and end users.

FIG. 13 depicts another embodiment of a network system with a plurality of PMUs, PDCs and end users in which a PDC is disposed between the end users and the communications connection.

FIG. 14a illustrates an embodiment of the configurable docking visualization tool or software.

FIG. 14b illustrates the computer system executing the visualization software.

FIG. 15 illustrates an embodiment of the main form for the configurable docking visualization tool or software.

FIG. 16 illustrates an embodiment of the main form which demonstrates horizontally docked panels, windows, or forms.

FIG. 17 illustrates an embodiment of the main form which demonstrates vertically docked panels, windows, forms.

FIG. 18 illustrates an embodiment of the main form which demonstrates complex tiled or nested docked panels, windows, or forms.

FIG. 19 illustrates an embodiment of a configuration form used in conjunction with configurable docking visualization tool or software.

FIG. 20 illustrates another embodiment of the configurable docking visualization tool or software.

FIG. 21 illustrates another embodiment of the configurable docking visualization tool or software in which pre-configured visualization forms are horizontally tiled.

FIG. 22 illustrates another embodiment of the configurable docking visualization tool or software in which pre-configured visualization forms are arranged in complex tiled or nested docked format.

FIG. 23 illustrates the Archive form for the configurable docking visualization tool or software.

FIG. 24 illustrates another embodiment of the configurable docking visualization tool or software utilizing pre-configured visualization forms.

FIG. 25 illustrates another embodiment of the configurable docking visualization tool or software in which the main form hosts a plurality of pre-configured visualization forms in a complex tiled or nested format.

FIG. 26 illustrates possible methods associated with the visualization tool or software.

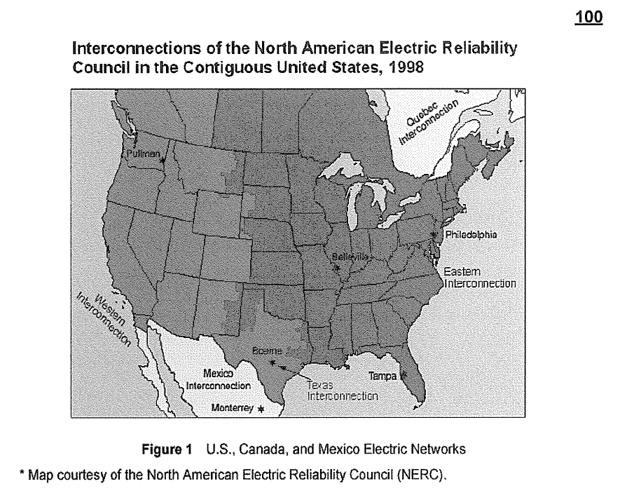

### DETAILED DESCRIPTION OF THE EMBODIMENTS

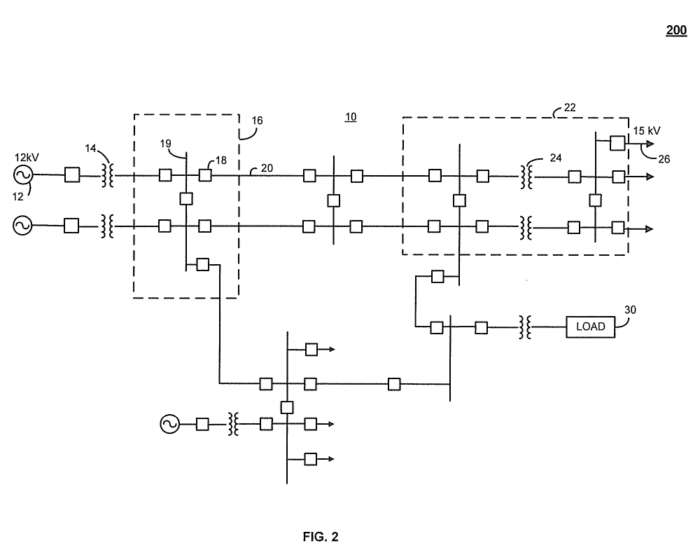

According to an aspect of the invention, FIG. 2 is a one-line schematic diagram of a power system 10 that may be utilized in a typical metropolitan area. As illustrated in FIG. 2, the power system 10 includes, among other things, a generator 12 configured to generate three-phase sinusoidal waveforms at, for example, 12 kV, a step-up transformer 14 configured to increase the 12 kV sinusoidal waveforms to a higher voltage such as 345 kV, and a first substation 16 including a number of circuit breakers 18 and transmission lines 20 interconnected via a first substation bus 19. The first substation 16 provides the higher voltage sinusoidal waveforms to a number of long distance transmission lines such as a transmission line 20. At the end of the long distance transmission line 20, a second substation 22 includes a step-down transformer 24 to transform the higher voltage sinusoidal waveforms to a lower voltage (e.g., 15 kV) suitable for distribution via a distribution line 26 to various end users and loads.

As previously mentioned, the power system 10 includes protective devices and procedures to protect the power system elements from abnormal conditions. Some of the protective devices and procedures act to isolate corresponding protected elements (e.g., the transmission line 20) of the power system 10 upon detection of short circuit or fault. Other types of protective devices used in the power system 10 provide protection from thermal damage, mechanical damage, voltage sags and transient instability.

The protective devices and procedures utilize a variety of logic schemes to determine whether a fault or other problem exists in the power system 10. For example, the protective device may be in the form of a protective relay which utilizes a current differential comparison to determine whether a fault exists in the protected element. Other types of protective relays compare the magnitudes of calculated phasors representative of the three-phase sinusoidal waveforms to determine whether a fault exists. Frequency sensing techniques and harmonic content detection is also incorporated in protective relays to detect fault conditions. Similarly, thermal model schemes are utilized by protective relays to determine whether a thermal problem exists in the protected element.

For example, protection for the generator 12 may be provided by a generator differential protective relay (e.g., ANSI 87G [ref. ANSI/IEEE Std C37.2]), protection for the transformer 14 may be provided by a transformer overcurrent relay or a transformer differential protective relay (e.g., ANSI 87T) and protection for the circuit breaker 16 may be provided by a breaker failure relay. Similarly, protection for the transmission line 20 may be provided by a phase and ground distance relay or a line current differential relay (e.g., ANSI 87L), and protection of the distribution line 26 may be provided by a directional overcurrent and reclosing relay. Many protective logic schemes are possible.

In almost all cases however, step-down current and voltage transformers are used to connect the protective relays to their corresponding higher power protected elements. The resulting lower secondary currents and voltages can be readily monitored and/or measured by the protective relays to determine corresponding phasors that are used in the various overcurrent, voltage, directional, distance, differential, and frequency protective relay logic schemes. As an indicator of the state of an electric power system, synchronized phasors must be communicated, time correlated across the system, and compared with other synchronized phasors in order to be valuable. More specifically, a comparison of synchronized phasors provides information regarding power angles across power lines, power transfer, system stability margins, and possible system isolation. Phasors may be obtained using any phasor measurement unit (PMU). For example, in this particular, the protective relay may obtain phasors from a portion of the power system and, therefore, be considered a PMU.

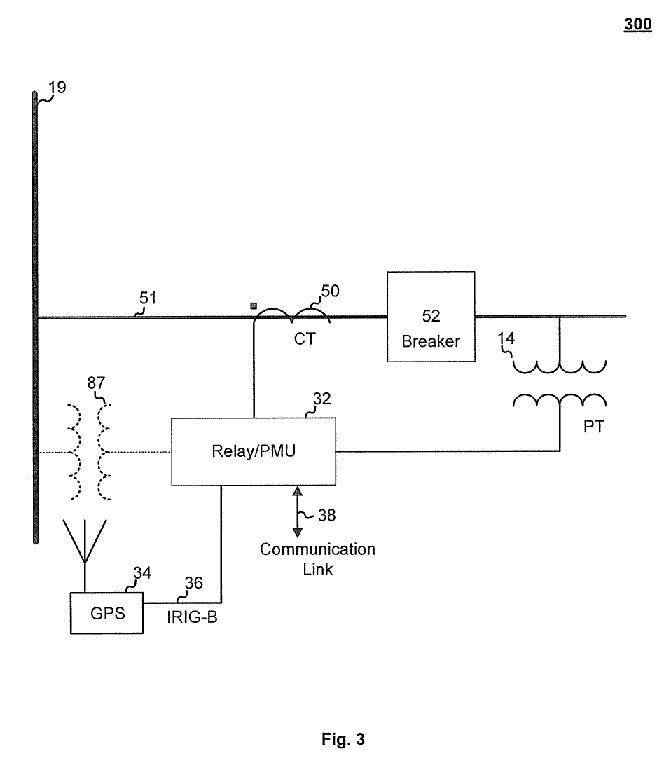

FIG. 3 illustrates a general system 300 diagram of a phasor measurement unit (PMU) 32, which may be in the form of a protective relay or any other such device, coupled with a high-accuracy clock (e.g., GPS clock) 34 using a communications link 38. Using the high-accuracy clock, the phasors measured or derived by the PMU 32 may further be associated with a time component. An example of a high-accuracy clock may include a clock which is synchronized to a global positioning system (GPS) or a Cesium clock. The high-accuracy clock submits a signal for synchronizing phasors based on Universal Time Coordinated (UTC). In order for an accurate phasor measurement, the synchronized signal is preferably accurate within about 500 ns of UTC. It is important to note that the phasors may be associated with a time component using any other time measurement means. Suitable forms of time communications links 36 include IRIG-B, IEC 61588 Ethernet link or other such communications links.

More specifically, the PMU 32 attains instantaneous current samples from line 51 through current transformer 50 and voltage samples from power bus 19 through power transformer 14. This system 300 may be within the power system 200 of FIG. 2. The PMU 32 processes these samples and thereupon derives phasors from such. In order to synchronize the samples, the phasors are marked with a certain time associated with the high-accuracy clock 34. In order to communicate such data to external devices such as other PMUs, protective devices, computers, etc., the PMU 32 generally further includes a binary output with another communications link 38 to such external devices.

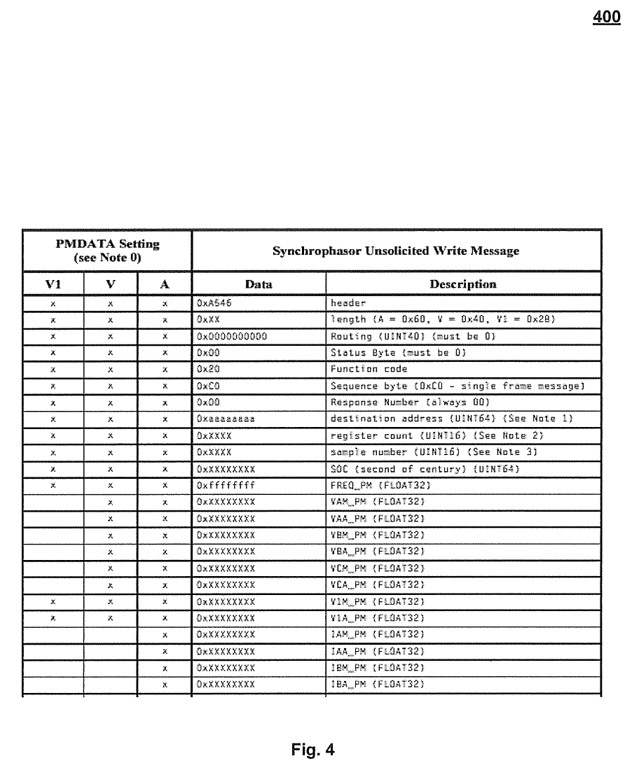

A setting in each phasor measurement unit in the form of PMDATA, for example, may define the analog quantities the unit will send in the message. The message may have the format as presented in FIG. 4. The message may further conform to an IEEE data format or any other suitable format.

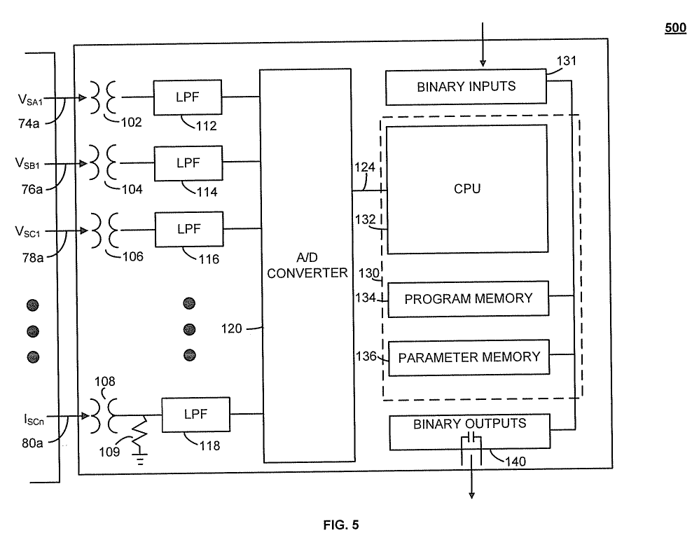

In one example, as shown in FIG. 5, the PMU 32 may be a protective relay 500 adapted to transmit synchronized phasors. FIG. 5 is a block diagram of an exemplary configuration of a protective relay 500 wherein the secondary voltage and current waveforms 74a, 76a, 78a to 80a are illustrated as V_{SA1}, V_{SB1}, V_{SC1} and I_{SCn}. Although only secondary voltage and current waveforms 74a, 76a, 78a to 80a are shown in FIG. 5, it should be noted that all secondary voltage and current waveforms (i.e., CT signals) of the current transformers are included.

Referring to FIG. 5, during operation, the secondary voltage waveforms 74a, 76a, 78a and current waveform 80a received by the protective relay 500 are further transformed into corresponding voltage and current waveforms via respective voltage and current transformers 102, 104, 106, and 108 and resistors 109, and filtered via respective analog low pass filters 112, 114, 116, and 118. An analog-to-digital (A/D) converter 120 then multiplexes, samples and digitizes the filtered secondary current waveforms to form corresponding digitized current sample streams (e.g., 1011001010001111).

The corresponding digitized voltage and current sample streams are received by a microcontroller 130, where they are digitally filtered via, for example, a pair of Cosine filters to eliminate DC and unwanted frequency components. From these samples, microcontroller 130 may also be adapted to measure and calculate phasors. Also, microcontroller 130 may be adapted to receive signals via binary inputs 131 from other external devices such as a high-accuracy clock, protective devices or external computers using a suitable communications link. For example, the binary inputs 131 may include, among other things, phasors from other protective devices or computers as described in U.S. Pat. Nos. 6,845,333 and 6,662,124. Binary input may further include data streams as those described in U.S. Pat. No. 5,793,750 for “System for Communicating Output Function Status Indications Between Two or More Power System Protective Relays” and U.S. Pat. No. 6,947,269 for “Relay-to-Relay Direct Communication System in an Electric Power System,” both of which are incorporated herein in their entirety and for all purposes. Using a high-accuracy clock (e.g., the GPS clock 34 of FIG. 3) as a binary input, microcontroller may thereupon synchronize phasors.

In this relay, the microcontroller 130 further includes a microprocessor, or CPU 132, a program memory 134, and parameter memory 136. The relay is adapted to measure phasor values and implement over current, voltage, directional, distance, differential, and frequency protective logic schemes. The logic elements associated therewith are generally programmed into the program memory 134 or permanently hard coded into parameter memory 136. The microprocessor 132 is coupled to the program memory 134 and the parameter memory 136 so that it may access the logic elements associated therewith in order to perform various protective functions and phasors.

The microcontroller 130 thereupon produces binary outputs 140 which may signal protective function or which may provide power system data. In one embodiment, the microcontroller produces a synchronized phasor measurement which may be transmitted over a communications link (e.g., the communications link 38 of FIG. 3) to other protective devices or to a WAN via Ethernet data transmission as will be described in detail below.

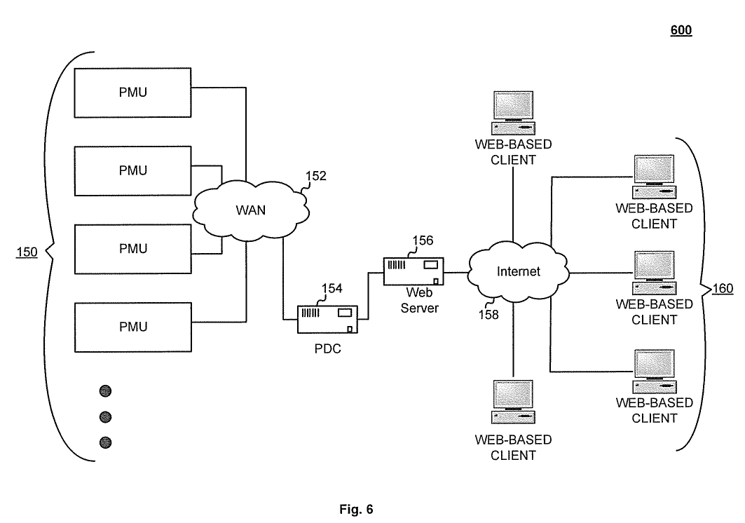

In another embodiment as illustrated in FIG. 6, multiple PMUs 150 are connected for communications over a wide area network (WAN) 152. Each of the PMUs 150 are associated with a secured portion of a power system. Each of the PMUs 150 are adapted to measure or derive synchronized phasors. PMU may further be adapted to measure and/or derive other power system values, including but not limited to frequency, voltage magnitude and angle, current magnitude and angle, change in frequency over time, digital values, analog scalar quantities and values derived from power system quantities. Accordingly, power system data as defined herein may include both synchronized phasors and also the other power system values as defined above. Each of the PMUs 150 may be on the same or even different power system grids. The power system data measured or derived by the PMUs 150 may further be associated with a time-element as discussed above (e.g., using a high-accuracy clock associated therewith).

For communication over the WAN 152, serial data is converted for Ethernet data transmission via an Ethernet transceiver for serial-only PMUs. Alternatively, for Ethernet native PMUs, such devices are directly connected to the Ethernet. Ethernet data is then sent via Transmission Control Protocol/Internet Protocol (TCP/IP), User Datagram Protocol (UDP),or other similar means over the WAN 152, which may be transmitted via several different communications media.

A device for aggregating and correlating the power system data, otherwise known as a power system data concentrator 154, may be connected to the WAN 152. The power system data concentrator 154 may be adapted to aggregate among other power system data, phasor data, and be therefore referred to as a phasor data concentrator (PDC). The PDC may further be adapted to time-correlate the power system data. The PMUs 150, WAN 152 and the power system data concentrator 154 are associated with a secured portion of the power system.

The power system data is to be transferred from the secured portion of the power system to a non-secure portion of the power system. Accordingly, a server 156 may be provided including a program for transferring the aggregated time-correlated power system data from the secured portion of the power system to a non-secure network. The server 156 may be in the form of a web server. In order to maintain security between the secured portion of the power system and the non-secure network, the server may include security communications means (e.g., a Virtual Private Network (VPN) connection, firewall or other similar security means).

The web server 156 provides the collected power system data over the non secure network (e.g., Internet 158) or other communications means to a plurality of web-based clients 160.

In yet another embodiment, the PDC 154 may be a software-based program residing in a dedicated server. Alternatively, the PDC 154 may be in another form or may reside in a computer. The PDC 154 may further be adapted to connect the PMUs 150 using TCP/IP connections over respective Ethernet connections. In one embodiment, the PDC 154 is adapted to receive power system data, which is recorded over a select period of time. Accordingly, power system data may be recorded in a buffer or otherwise be stored in a database. The stored power system data may be used to provide historical data or trend information.

As discussed above, the PDC 154 is adapted to receive power system data. For example, the power system data may include an embedded time stamp. The time stamp provides an absolute reference to which all data can be compared to provide relative reference between different data for indication of phase angle shift, error in time alignment, and error in phase angle. The time stamp may be in the form of a second of century (SOC), wherein a unique message label, message number or fractional second for further subdividing the SOC is implemented. For example, at data reception, the PDC 154 may correlate each message using the SOC and message number in a selected buffering system.

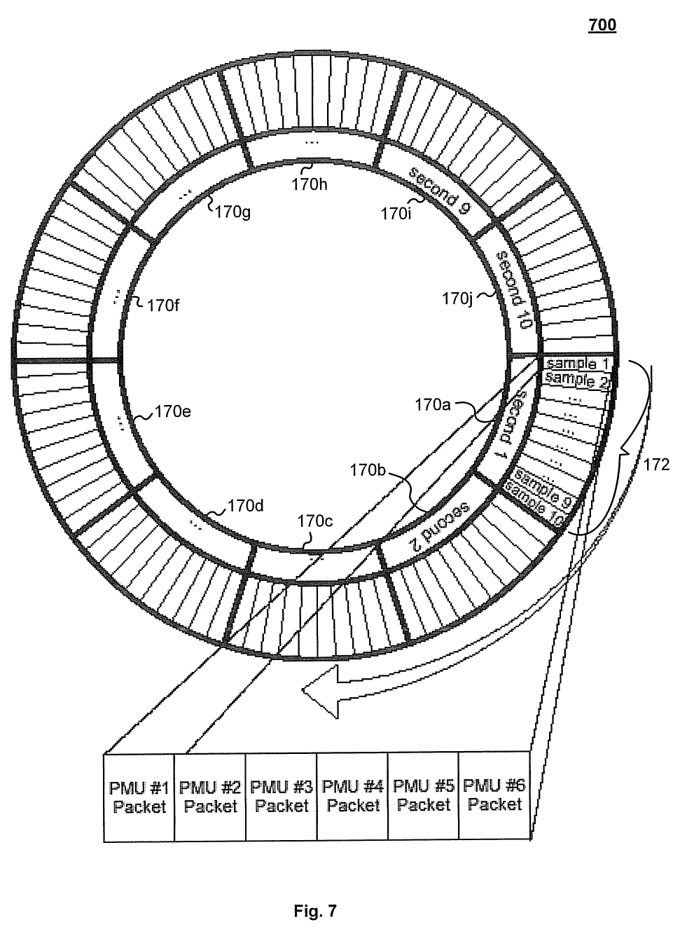

In yet another embodiment, the program for transferring the aggregated time-correlated power system data from the secured portion of the power system to a non-secure network may include a buffer. In one example, a ten-second buffer may be provided as illustrated in FIG. 7. The buffer 700 comprises of 10 slots 170a-j, each storing one second of data from all of the PMUs 150. Although a ten second buffer is described in this embodiment, other longer or shorter buffers may further be implemented. The slots 170a-j are further subdivided into various sample allocations 172. In this case, although sample allocations 172 for each slot are shown in this embodiment, other sized sample allocations may further be implemented. In this way, power system data may be recorded in this buffer.

In yet another embodiment, the program for transferring the aggregated time-correlated power system data from the secured portion of the power system to a non-secure network may be in the form of a script. In one example, a script is implemented using the buffer 700 of FIG. 7. The script moves the power system data from the PDC to a web server. The web server runs the script that periodically polls the PDC using a UDP or any other comparable protocol. The script may further be adapted to ensure and enhance the completeness of data transmitted from the PDC to the web server. For example, the script analyzes the packets sent by the concentrator and chooses the oldest data set within the buffer period that includes responses from the most PMUs. Accordingly, the script or other comparable program implemented provides for a real-time streaming data while providing minimal latency. In this embodiment, a one-second refresh rate is implemented although other suitable rates may further be used which minimizes internet communications traffic.

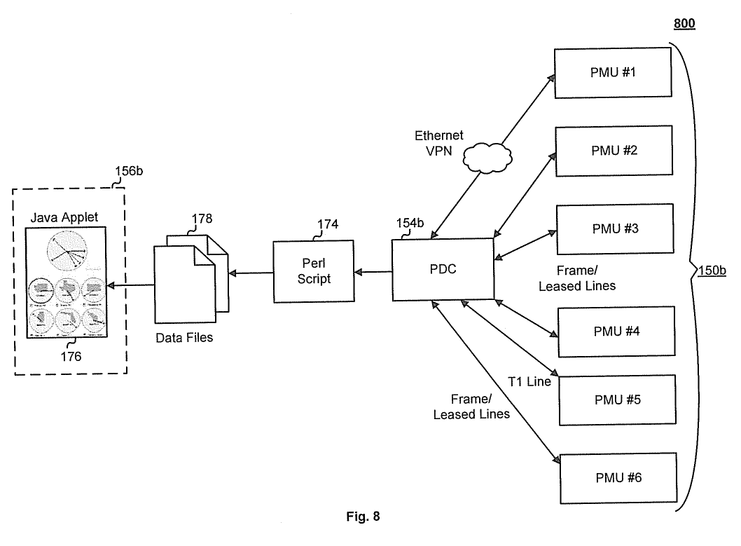

In yet another embodiment as illustrated in FIG. 8, the program may be written in the Perl script 174 programming language for moving the power system data from a PDC 154b to a web server 156b. The web server 156b runs Perl script 174 that periodically polls the PDC 154b using a UDP or any other comparable protocol. The Perl script 174 causes data files 178 to be written to the web server 176. The web-based clients may access the power system data from multiple PMUs 150b via an applet 176, which is downloaded along with a respective web page and runs from within the client's web browser 156b. An applet is a program that is generally written in the Java programming language and embedded within a web page; other languages and methods are also available. The applet 176 is generally downloaded along with the web page by the web-based client and runs from within the web-based client's web browser. For example, the applet 176 may, among other things, collect data from the web server 156b, calculate phase angles, and render graphical representations of power system data.

More particularly, when a web-based client accesses the web page, the Java applet 176 is loaded from the web server 156b. When the Java applet 176 is launched in a web browser, it reads the data file 178 that contains the list of PMUs 150b connected to the PDC 154b. The Java applet 176 then would periodically read the data file 178 that contains the PMU data to be displayed. For example, one applet may use data to configure the display to show phasor plots for each PMU 150b connected to the PDC 154b. Another applet may start a ten-minute rolling display of frequency. Other web page programming languages other than Java may further be implemented such as HTML or XML.

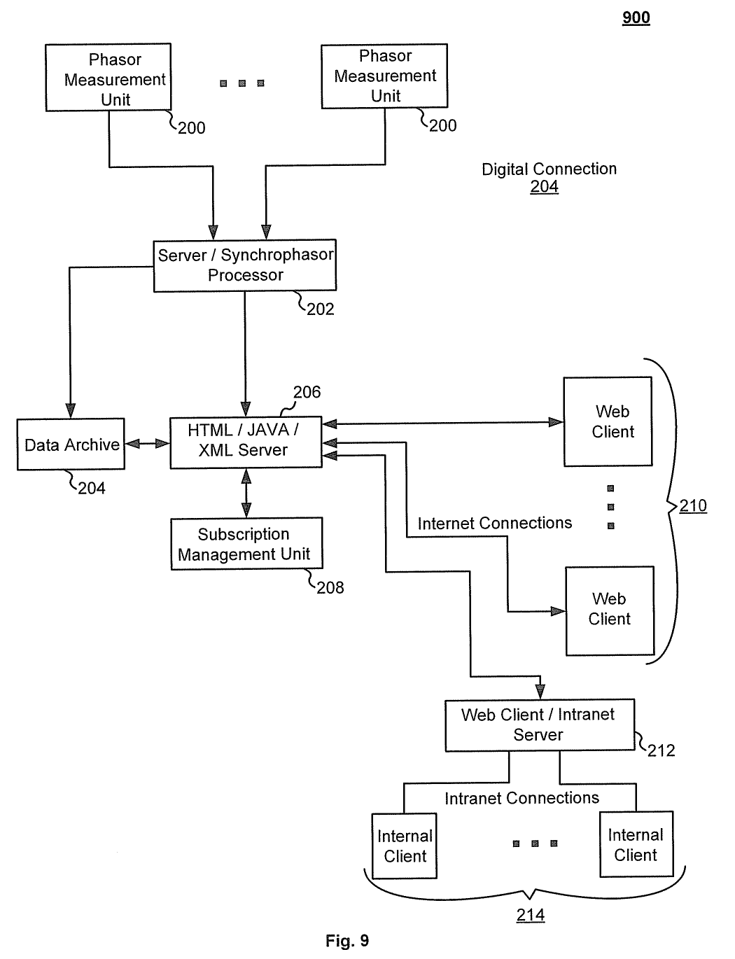

FIG. 9 illustrates a system in accordance with yet another embodiment of the present invention. This system includes a plurality of PMUs 200. These PMUs 200 may be coupled with a high-accuracy clock (e.g., GPS clock) using a communications link (e.g., IRIG-B or IEC 61588 Ethernet link). The PMUs are connected to a server/Synchrophasor Processor 202 using for example TCP/IP connections over respective Ethernet or direct serial connections 204. The server/Synchrophasor Processor 202 receives power system data with embedded time stamp such as described in detail above with respect to the PDC. At data reception, the server/Synchrophasor Processor 202 may further be adapted to time correlate the data and data number in a selected buffering system.

A database in the form of a data archive 204 is coupled to the server/Synchrophasor Processor 202 for receiving power system data and recording such over a select period of time. The server/Synchrophasor Processor 202 and database 204 may be connected to a web server 206 which may be adapted to implement JAVA, HTML, XML, or other web-based language. Perl script or other such program may be implemented for moving the power system data from the server/Synchrophasor Processor 202 to a web server 206 or the data archive 204 to the web server 206. The data transfer program may further be adapted to ensure that enhance the completeness of data transmitted from the server/Synchrophasor Processor 202 to the web server 206 or the data archive 204 to the web server 206.

The web server 206 may be connected to a subscription management unit 208 and web clients 210 via conventional Internet connections. The web clients 210 connected to the web server 206 may access the phasors via an applet. Each of the web clients 210 may further an intranet server 212 whereupon multiple internal clients 214 are established.

A subscription management unit may 208 be used to limit access to each web client 210 or internal client 214. For example, the subscription management unit 208 may be used to password protect and maintain a payment system, whereupon a web client 210 or internal client 214 would be required to provide password and/or payment to access such data from the web server 210. For example, a subscription service may be implemented whereupon power system data is stored in the web server 210. A web client 214 may access such data to view power system data, including synchronized phasors, among systems or PMUs within the same electric power system or among different electric power grids.

For example, upon receipt of a request from a customer (e.g., either a web client or internal client) using a web browser, the web server 206 provides access to an online subscription management tool hosted by the web server 206. Utilizing various web pages transmitted via the customer's browser, the customer submits a user name and password. The user name and password is submitted to the web server which verifies the customer's account balance by comparing such with data stored in the server. In this way, the web server 206 may limit access to only customers with subscriptions thereto.

In accordance with the various aspects of this invention, a display is provided to the web client wherein real-time power system data, including synchronized phasors, may be visualized. The system may also be adapted such that it displays the status information wherein the system is offline or does not have a synchronized time source.

In accordance with another aspect of the invention, the server may include a program for graphically depicting the power system data. For example, the applet may include graphical depiction of such data. In yet another embodiment, portions of the power system and the power system data associated therewith may be graphically depicted on a map. In one example, the user may select either synchronized frequency measurements or synchronized voltage magnitudes for various locations within an electric power system or among different electric power grids.

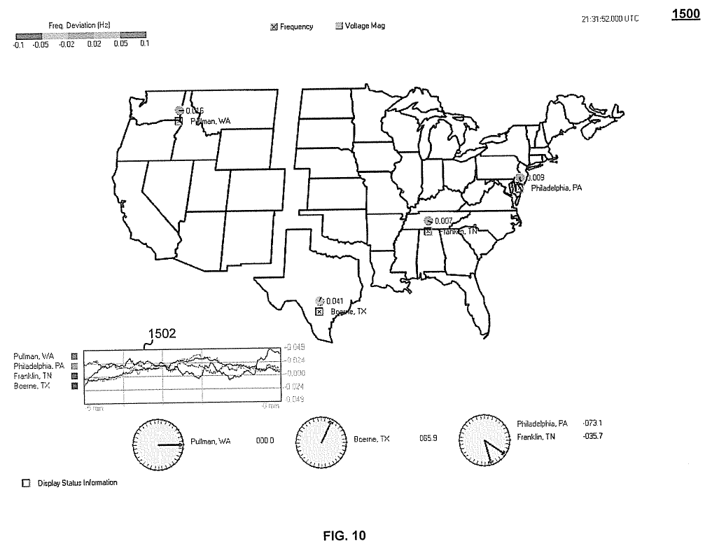

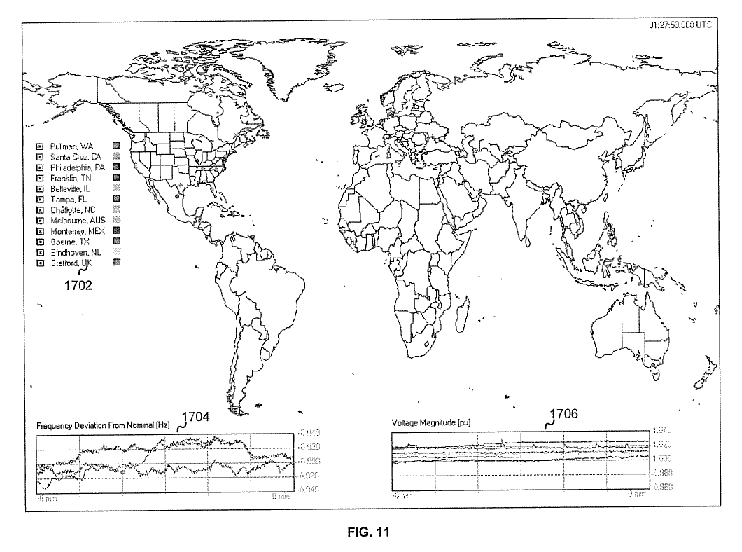

For example, FIG. 10 illustrates a graphical display 1500 of power system data, i.e., frequency deviation 1502 over a period of five minutes of United States on a web page. FIG. 11 illustrates a global visualization of power system data. For example, the left side of the graphical display depicts the validity of data states from a list of 12 sites 1702 from around the world. Each PMU corresponds to a solid dot in the world map. The dots may be depicted in several different colors, each represent a state. For example, gray may depict that the PMU is offline; yellow may depict the time of PMU is not synchronized to a high-accuracy clock; red may depict the data that is displayed and transmitted from the PMU is not valid; and green may depict valid message and time is good, etc.

In yet another embodiment, the graphical display may further include a depiction for other power system data. This may be depicted in text or graphical format. For example, the power system data may appear at the PMU location on the map or otherwise in a listing format. Also, the graphical display may include a graph 1704 for displaying frequency deviation from nominal value for the select period of time (e.g., in this case, for the last 6 minutes). Another graph 1706 may also be provided for displaying voltage magnitude per unit for a select period of time (e.g., in this case, for the last 6 minutes).

In yet another embodiment, the graphical display may depict when a PMU is selected from the graphical screen (e.g, through another color or flashing dot associated therewith).

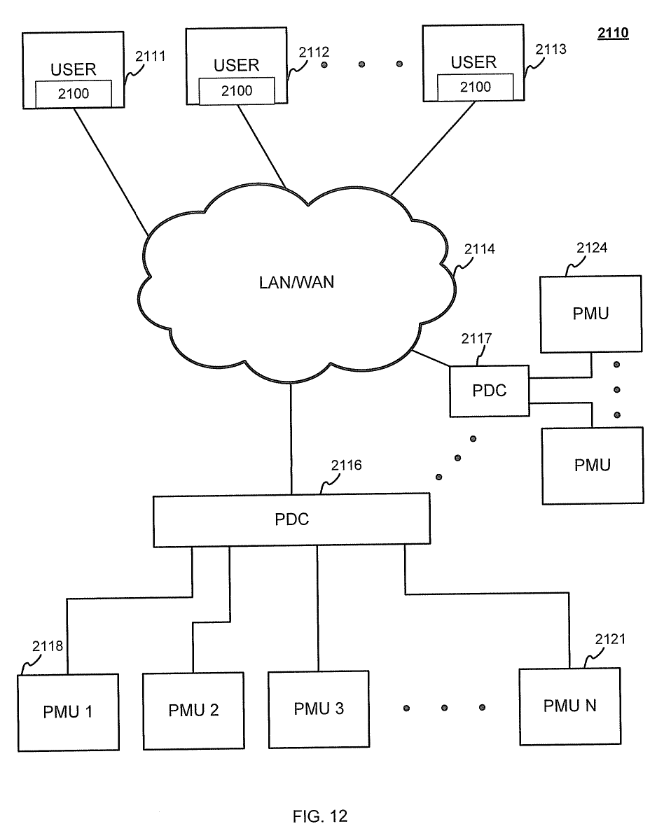

FIG. 12 shows another embodiment or network system 2110 in which a plurality of Phasor Data Concentrators (PDCs) (2116 to 2117) are accessible via a communications connection (2114). The communications connection 2114 may consist of Wide Area Networks (WAN), Local Area Networks (LAN), Supervisory Control and Data Acquisition (SCADA) systems, phone dial up, leased line, Ethernet, wireless communications utilizing cellular, RF, microwave, or infrared communication means, fiber optic, or any similar connection method known in the art. In this embodiment the PDCs are disposed between the PMUs 2118 to 2124 and the communications connection 2114. Communications via the connection (2114) may also be secured or redundant through either known encryption methods or known communication protocols such as Ethernet, IEC 61850, or DNP. The PDCs 2116 to 2117 are connected to and aggregate the data created by the PMUs 2118 to 2124. The PDCs then communicate the aggregated data to the multiple end users 2111 to 2113. In this embodiment, the PDCs may act as serves or act in conjunction with independent servers (not shown) integrated with the communication connection 2114, as shown, for example, in FIG. 6. Each end user consists of a computer system executing the configurable docking visualization software or tool 2100. The configurable visualization docking software 2100 is able to receive data from PDCs and the PMUs (via the PDCs). By receiving data from the PDCs and PMUs, the configurable visualization docking software 2100 monitors the operations of either the PDCs or the PMUs.

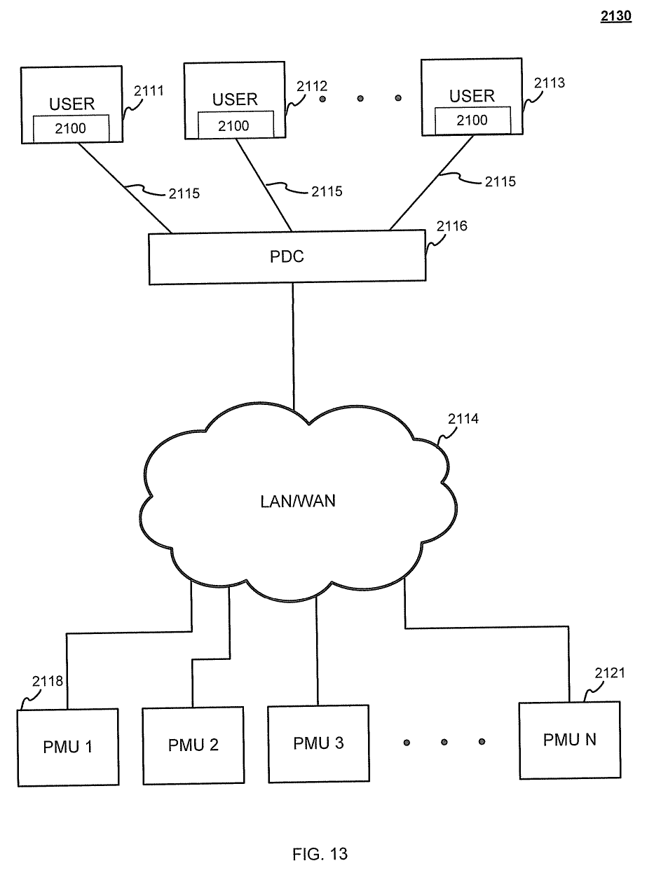

FIG. 13 demonstrates another embodiment 2130 where multiple users 2111 to 2113 view real-time synchronized power system quantities measured by a plurality of PMUs 2118 to 2121. In this embodiment, the PDC 2116 is disposed between a plurality of end users 2111 to 2113 and the communications connection 2114. In this embodiment, the PDC 2116 receives data from or accesses the PMUs using the communications connection 2114. The PDC 2116 then transfer the aggregate data to users 2111 to 2113 via individual communications connections 2115. The individual communications connection 2115 may be via a wired means, wireless point-to-point means or some other private means of inter-computer communication. Each end user 2111 to 2113 consists of a computer system executing the configurable visualization docking software or tool 2100. The configurable visualization software 2100 is able to receive data from the PDCs and the PMUs (via the PDCs). The configurable docking visualization software 2100 will be discussed in more detail below.

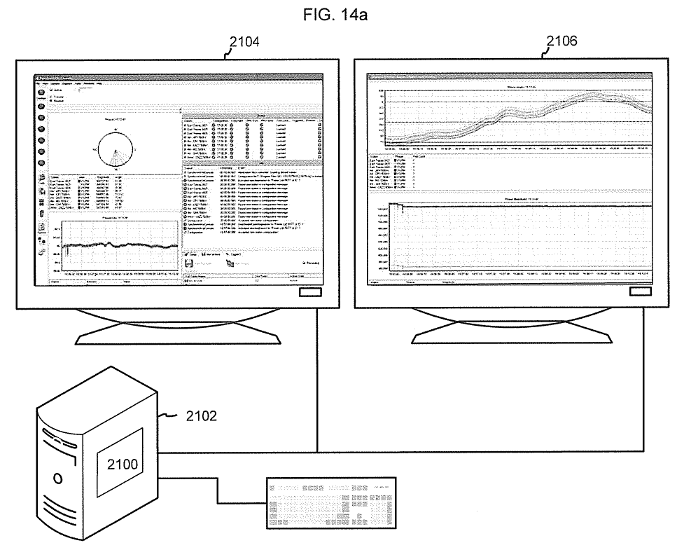

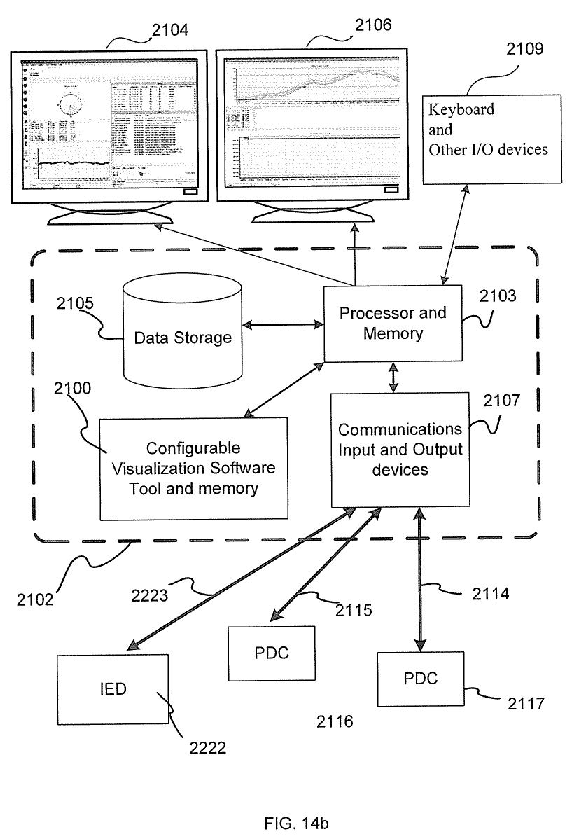

As shown in FIG. 14a, the configurable docking visualization software 2100 resides in a computer system 2102 utilized by the end user. In this embodiment, the configurable docking visualization software 2100 operates on a computer system 2102 and within a Windows® operating system environment. However, in other embodiments, the software 2100 may execute within any other operating system environment. The configurable docking visualization software 2100 utilizes pre-configured visualizations, which display data associated with the operation of PMUs, such as time aligned or real-time synchronized power system quantities. These visualization can be displayed by the software on one or more visual display devices 2104 and 2106. These visual display devices are defined to include monitors, instrument displays, local area network displays, screens, projections or LCD screens of handheld devices. The data can be displayed in a number of fashions, including but not limited to, real-time trending displays, instantaneous displays, system to system performance composite displays, etc.

As illustrated in FIG. 14b, the computer system has at least one processor (generically referred to as a data processor) and memory 2103, data storage 2105, and access to a communications connection 2107, such as the communication connections 2114 and 2117 as illustrated in FIGS. 12 and 13. First, the system 2102 executes the configurable visualization software tool 2100 in a known manner. The configurable visualization software tool 2100 resides in memory and is executed by the processor 2103. The system 2102 operates and interacts with the user based on the instructions of the software 2100. Consequently, the functionality and the operation of the system 2102 and the software 2100 will often be made in reference to only the configurable visualization software 2100.

In addition, those in the art will appreciate that the configurable visualization software 2100 may exist as single software program residing in memory or be separated into multiple software programs, each program being independently executed by the processor. Thus, the term software may also apply to more than one program that interacts with and instructs the system 2102.

The configurable docking visualization software 2100 interacts with a user by means of input/output (I/O) devices 2109. Typically, the user utilizes a keyboard 2109 and a mouse to input data and receives the output from the configurable visualization software 2100 on one or more monitors 2104 to 2106. The configurable visualization software 2100 preferably uses known programming routines and software techniques to permit the user to enter and receive data. The system 2102 also includes a data storage mechanism 2105 that permits the configurable visualization software 2100 to store, retrieve, copy, and delete data.

The computer system 2102 is connected to the PDCs 2116 and 2117 via the communication connections 2114 and 2115, as discussed above, such that the configurable visualization software 2100 receives information or data from the PDCs 2116 and 2117 by way of these connections and the communication input and output devices 2107. However, the configurable visualization software 2100 does not have to connect to PDCs to receive data. The configurable visualization software 2100 can receive data from other intelligent electronic devices (IEDs) 2222 by means of other communication connections 2223, consisting of, for example, wired serial connections, wired network connections, Ethernet connections, or a wireless connections.

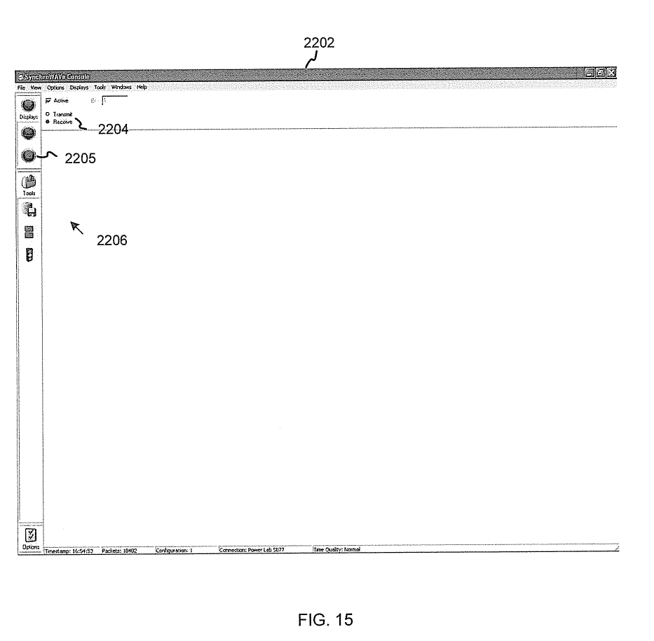

FIG. 15 illustrates an embodiment of the configurable docking visualization tool 2100 and its main form 2202 within a Windows® operating system environment The main form 2202 is a graphical user interface and presented to the end user on one or more screens, such as the monitor 2104 and 2106 shown in FIG. 14a. The main form 2202 includes a Tool Bar 2206 and Display Options Bar 2205, which assist an end user in customizing the display of data and real-time synchronized power system quantities. For example, icon 2204 indicates the status of data, such as the transfer of data, by flashing in receive mode or transmit mode.

The Display Options Bar 2205 allows an end user to select among different pre-configured visualizations that display data associated with the PMUs, such as synchronized phasor data, power system quantities, or power system values. These pre-configured visualizations include, for example, trending visualization for phasor angles, phasor magnitude, programmable analog scalars, digital data points, frequency and frequency deviation over time, and instantaneous display of relative phasor angles. These pre-configured visualizations come pre-programmed within the visualization software 2100 and are a means to efficiently communicate data to the user. Because the visualization are pre-configured, the user does not waste time creating specific visualizations.

The visualizations and displayed information can be configured in full window, tiled windows or nest windows. These windows or sub-forms may be docked next to each other within the main form 2202. Docking visualizations or nesting visualizations allows the user to create a customizable display by placing visualizations next to other visualizations. Docking techniques encapsulate pre-configured visualizations in dockable forms. Docking maximizes the use of the available space on the monitor screen while presenting a user with information that may only be attainable by comparing or correlating two or more visualizations. In other words, the visualization software allows a user to see changes in the power system state that may only be indicated by changes in a combination of different power system quantities.

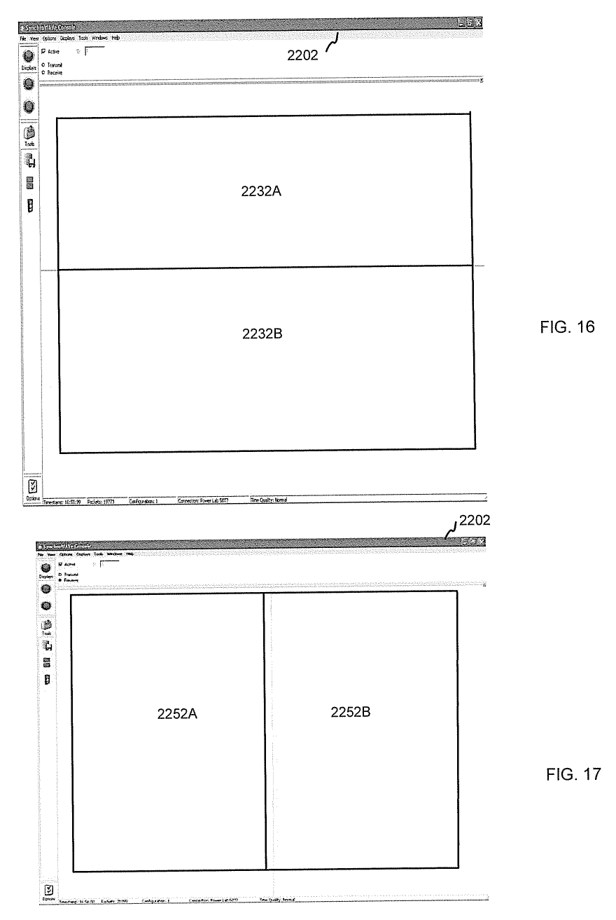

FIG. 16 illustrates an embodiment of the main form 2202. The main form 2202 provides the capability to divide the visible screen into two or more panels or sub-forms. These sub-forms can be adjusted either vertically or horizontally. For example, the main form in FIG. 16 is configured in to horizontally tiled docking sub-forms 2232A and 2232B. FIG. 17 illustrates another embodiment of the main form 2202 and is configured to display the pre-configured visualizations in vertically tiled docking sub-forms 2252A and 2252B within the main form 2202.

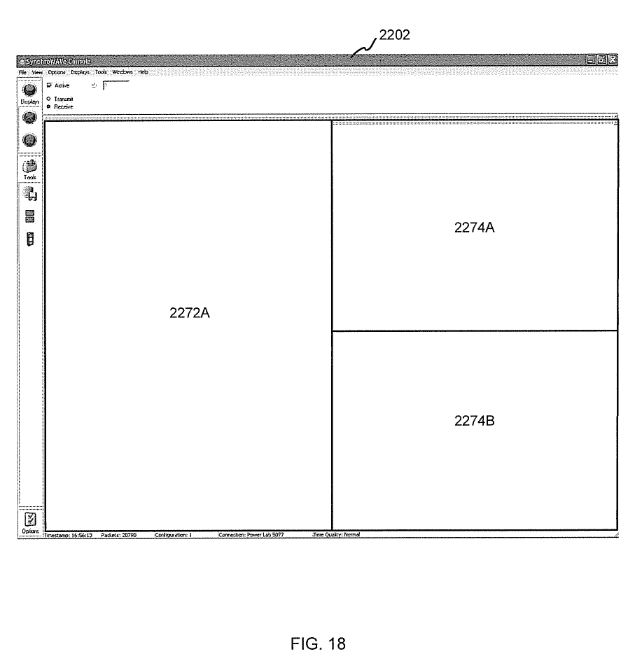

An example of another embodiment is shown in FIG. 18. In this embodiment, the main form 2202 is configured to display complex tiled or nested docking forms 2272A, 2274A, and 2274B within the main form 2202. Docking allows a single screen or display to be divided into several panels or forms, wherein various pre-configured visualization forms can be loaded. The windows or docking forms in this embodiment are configured both vertically 2272A and horizontally 2274A and 2274A on the same monitor screen. As can be appreciated, the docking forms may have numerous orientations while still falling within the scope of the invention and claims. The docking forms 2232A, 2232B, 2252A, 2252B, 2272A, 2274A and 2274B may receive and display any of the pre-configured visualizations selected by the user via the Display Options Bar 2205. The tiled, nested, or full screen visualizations can also be display on a plurality of monitor screens, as shown in FIGS. 14a and 14b.

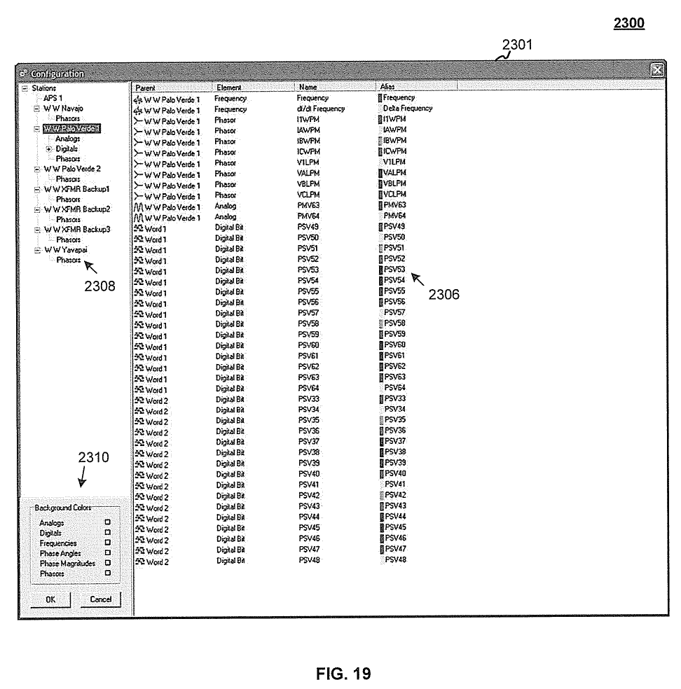

In yet another embodiment 2300, illustrated in FIG. 19, the configurable docking visualization software 2100 includes processes and forms for modifying the properties of the information to be displayed using the pre-configured visualizations, such as the power system quantities measured by the PMUs/PDCs of a station requested by the end user. FIG. 19 illustrates a configuration form 2301 for modifying the properties of the information. The configuration form 2301 displays a plurality of stations in a tree view 2308. Each station in the tree view 2308 represents a PDC or PMU connected to a network such as the network 2110 as shown in FIG. 12. The configuration form 2301 also displays the PMU data 2306 of the selected station and various properties of this data such as, for example, the name of the measure, color of trend line used in the visualizations, alias of the measurement value, etc. The option to select different background colors, as provided by the colors selection icon 2310, provides optimal trend contrast for ease of viewing by the end user.

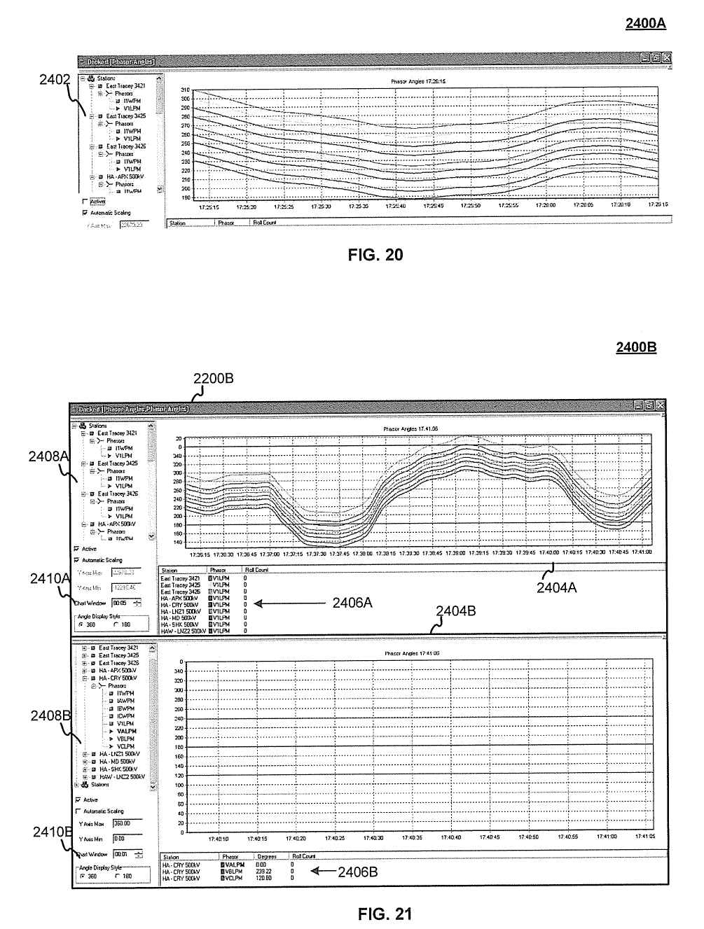

FIG. 20 illustrates an example of a pre-configured visualization form 2400A, which displays a trend of the phasor angles of various stations for a defined period of time. The visualization 2400A can be configured to display unique colors for each the phasor angles for the various selected stations. Stations are selected by individually selecting the stations or phasors of the PMU by using the tree view of the station legend 2402. The data marked with triangles represent the data measurements that are displayed by the trending visualization 2400A.

FIG. 21 illustrates another embodiment or example of the visualization software 2100 which tiles horizontally the pre-configured visualization forms 2404A and 2404B within the main form 2200B. In this example of horizontal tiling or nesting, the trending visualization form 2404A is configured to display phasor angles from multiple stations, in a manner similar to the visualization 2400A in FIG. 20. The station legend 2408A shows multiple PMU data sets associated with visualization from 2404A. By using the controls 2410A, the user may select the X-Y coordinate range, such as the display style, and whether to display time (x-axis) as a defined period in automatic scale. The graph legend 2406A correlates the lines of the graph with the origin of the data being represented.

Pre-configured trending visualization form 2404B displays phasor angles for a single station selected from the tree view 2408B showing PMU data sets (e.g. HA-CRY 500 kV), where the three phase (VALPM, VBLPM, and VCLPM) phasor measurements are selected. The three phasor measurements (VALPM, VBLPM, and VCLPM) and their corresponding X-Y coordinate range appear in the graph of the visualization form 2402B. The X-Y coordinate range is selected by manipulating the controls 2410B. The graph legend 2406B correlates the lines on the graph with the origin of the data being represented.

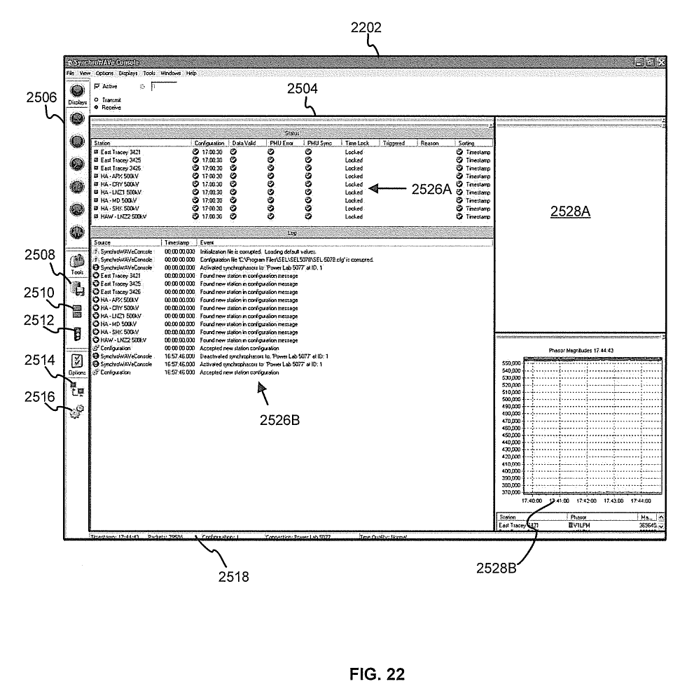

FIG. 22 illustrates an example of complex tiled or nested docked forms 2504, 2528A and 2528B within the main form 2202. In this configuration, the window within the main for 2202 includes three forms 2504, 2528A and 2528B. The forms 2504, 2528A and 2528B do not necessarily have to be used in conjunction, but could be utilized or docked with other forms, such as those in FIGS. 20 and 21. The form 2504 on the left of this embodiment displays a status information form 2526A and a status log 2526B. The status information form 2526A reports instantaneously the status or change in status of all the stations monitored within connected network 2110. The status log 2526B maintains and displays a log of all the status changes of the stations. Empty form 2528A is left blank to be configured by a user. To configure this form 2528A, the user selects a pre-configured visualization from the Tool Bar 2506. Additionally, the user can drag and drop a pre-configured visualization form into empty form 2528A. The form 2528B, just below form 2528A in this embodiment, displays the trended power system quantities, such as the phase magnitude, for multiple stations.

The Tool Bar 2506 includes other functions represented as icons 2508, 2510, 2512, 2514, and 2516. The data archive icon 2508, loads into the main window the Archive form. The Archive form allows the user to store in an archive the power system quantities from one or more PMUs, PDCs or intelligent electronic devices. Docking icon 2510 opens additional docking forms within the main form 2202. Additional docking forms can also be created by dragging and dropping pre-configured visualization forms into the main form 2202. The status icon 2512 loads the status form 2504, which also contains the status information form 2526A and status log form 2526B, in the main form 2202. The status information form 2526A and status log 2528A are placed into an empty docking form such as 2528A or an addition docking form is created within the main form to hold the status form and log. The communications icon 2514 loads the communications form, which provides information about the network system 2110 and the communications connection 2114. The configuration icon 2516 loads the configuration form 2301 within the main form 2202.

The Status Bar 2518 at the bottom of main form 2202 displays information about the configuration of the software, the network connection, time quantity and timestamp for the data received by the visualization software.

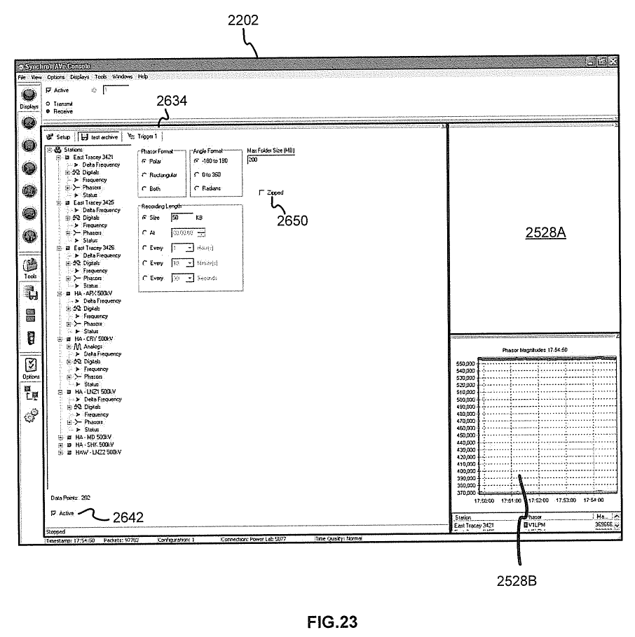

In yet another embodiment, FIG. 23 illustrates the configurable docking visualization software tool 2100 which is displaying phasor information and can be configured for continuous data recording. The nested or docked Archive form 2634, which is accessible via the archive icon 2508, is used to configure the visualization tool 2100 to record real time continuous power system quantities data by selecting a station and using either a continuous recording or trigger bit function in the PMUs. The bit trigger function of the visualization tool 2100 incorporates IEEE defined trigger bits to capture events based on preprogrammed alarms. When a PMU's preprogrammed alarm is trigger by an event, trigger bits are communicated through PDC and the communications connection 2114 to the visualization software tool 2100. The trigger bits then activate event recording for pre-defined events. The diagnosis of certain events may require more information, a longer recording time period or specific power system quantities. Based on the trigger bits received by the visualization tool 2100, the tool 2100 will capture the necessary data required for an adequate diagnosis by the end user. The PMU's 2118-2121 (shown in FIGS. 12 and 13) trigger bits can be programmed internally to respond to any value measured inside the relay, such as undervoltage, frequency rate of change, power swing, unbalance, or any other analog or digital value. In one embodiment, the visualization tool 2100 has a default recording size of 50 kB. Box 2650 can be selected to maintain the measured and recorded data in a compressed file.

As demonstrated in the prior embodiments, form 2528B in FIG. 23 displays the real time phasor magnitudes over a defined duration of time, while form 2528A is an empty form that is capable of receiving or hosting a pre-configured visualization.

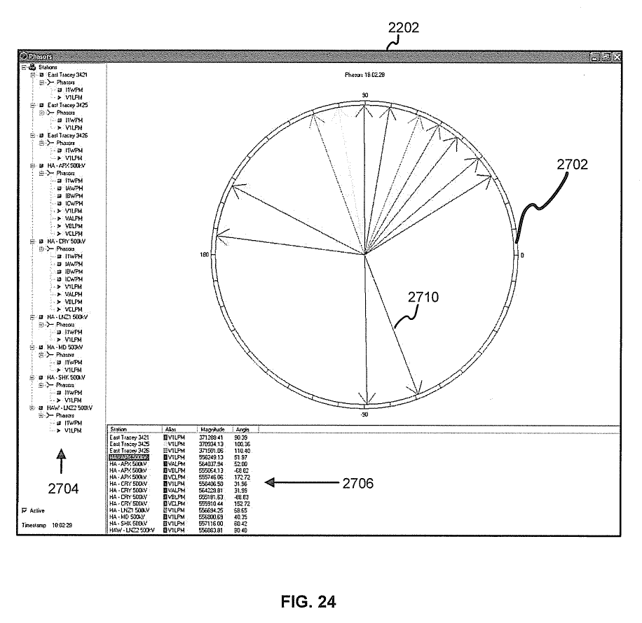

FIG. 24 illustrates another embodiment in which the main form 2202 is configured to present instantaneous phasor data in polar display 2702. In this embodiment, the real time phasors are realized on a polar plot. Each of the respective instantaneous phasor angles for each corresponding station is represented by an arrow 2710 (colored). Legend 2706 shows the respective stations and respective phasor information within the network being monitored. Tree view 2704 allows for the selection of various phasors from connected PMUs 2118-2121 for viewing in the polar display 2702.

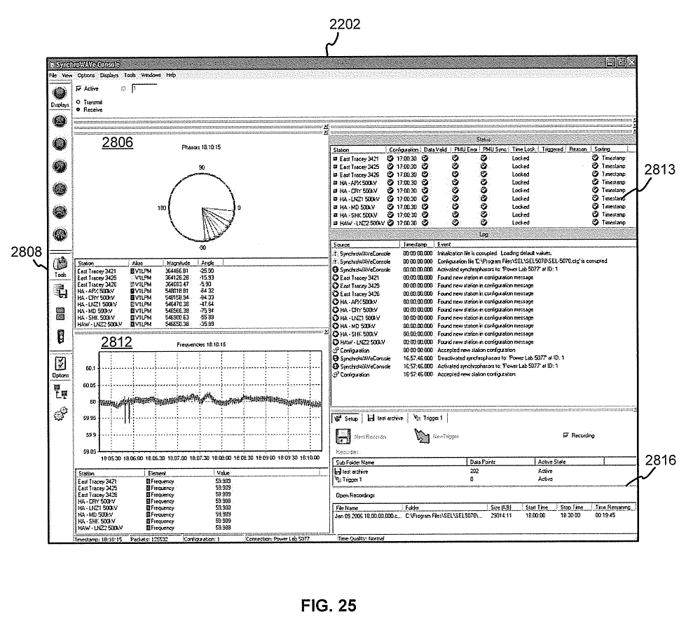

FIG. 25 depicts another embodiment illustrating the flexibility in displaying multiple docking forms and visualization with the software tool 2100. In FIG. 25, multiple pre-configured visualizations are nested in docked forms. These visualizations present a plurality of different power system quantities and values and reflect the instantaneous state of the electric power system. Docked visualization form 2806 displays respective instantaneous phasor angles. Docked visualization form 2812 displays a frequency trend over a defined period of time. Docked visualization form 2813 displays instantaneous and historical status information in association with specific stations. Docked visualization form 2816 displays archiving or recording of respective real time power system quantities. While FIG. 25 demonstrates that a plurality of different forms can be docked within the main form 2202, these forms may be separated over several monitor screens as demonstrated in FIG. 14.

In yet another embodiment, the visualization software tool 2100 may further include a pre-configure visualization depiction for other power system data. This may be depicted in text or graphical format. For example, the power system data may appear at the PMU location within a preconfigured visualization containing a map or may be displayed in a list. Also, pre-configured visualizations may include a graph, such as the graph 1704 depicted in FIG. 11, for displaying frequency deviation from nominal value for the select period of time (e.g., in this case, for the last 6 minutes). Another pre-configured visualization may include a graph, such as the graph 1706 in FIG. 11, may also be provided for displaying voltage magnitude per unit for a select period of time (e.g., in this case, for the last 6 minutes).

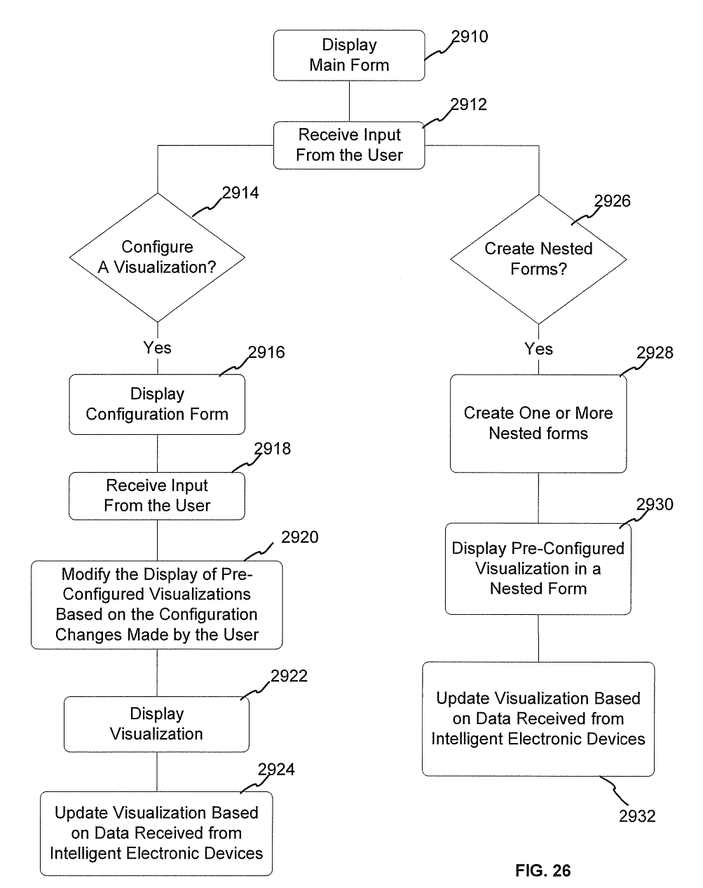

The visualization software tool 2100 may have numerous methods associated with its operation. In one embodiment, which is illustrated in FIG. 26, the visualization software displays a graphical user interface or a main form 2910, such as the main form 2200 shown in FIG. 22. The main form 2910 then receives input from the user 2912, which directs the operation of the visualization software tool 2100. For example, the user may wish to configure a visualization 2914 using the configuration form 2301 as shown in FIG. 19. The visualization software tool 2100 will then display a configuration form 2916. After receiving additional input, the visualization software tool 2100 modifies the visualization 2920 based on the user's selections and displays the visualization 2922 to the user. The visualization software 2100 will continue to update the visualization 2924 based on additional data it receives from PMUs, PDCs or other intelligent electronic devices (IEDs).

The user may also create additional nested forms to encapsulate additional visualizations within the main form 2910. After the user selects to create one or more nested forms 2926, the visualization software will create nested forms 2928 in the main form. The forms can be nested horizontally, vertically, or within other nest forms to create a complex tiled effect. Creating nested forms may also include creating a second main form or additional forms on another monitor or display device. After the forms are created, the user may insert pre-configured visualizations, such as graphs or plots of power system data. The user may also create nested forms by dragging and dropping pre-configured visualizations into the main form. After the visualization is encapsulated in a form and displayed to the user 2930, the user may configure the visualization using the configuration form 2301. The visualization software 2100 will continue to update the visualizations 2932 within the nested forms based on additional data it receives from PMUs, PDCs or other intelligent electronic devices (IEDs).

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

We claim:

1. A system for displaying information gathered from phasor measurement units, comprising:
a plurality of phasor measurement units;
a computing system comprised of at least a data processor;
a first display for visually depicting information;
a communications connection;
a software program;
said software program being executed by the data processor;
said data processor being directed by said software program to collect data associated with the phasor measurement units via the communications connection;
said data processor being directed by said software program to create a form on said first display;
said data processor being directed by said software program to divide said form into one or more sub-forms; and
said data processor being directed by said software program to display visualizations of the data associated with the phasor measurement units in one or more of the sub-forms.

2. The system of claim 1 further comprising:
a second display;
said data processor being directed by said software program to create a second form on said second display;
said data processor being directed by said software program to display data associated with the phasor measurement units in one or more of the sub-forms.

3. The system of claim 2 further wherein
said data processor being directed by said software program to configure and the visualizations to optimize a user's ability to monitor a power system.

4. A system for displaying information gathered from phasor measurement units, comprising:
a plurality of phasor measurement units;
a computing system comprised of at least a data processor;
a display for visually depicting information;
a communications connection;
a software program;
said software program being executing by the data processor;
said software program directing said computer system to receive data associated with the phasor measurement units via the communications connection;
said software program directing said computer system to create one or more docking window on said display; and
said software program directing said computer system to display data associated with phasor measurement units in one or more of the docking windows.

5. A computer program product having a computer readable medium having computer program logic recorded thereon for displaying information associated with synchronized phasors, phasor data collectors, and phasor measurement units comprising:
means for receiving data associated with one or more phasor measurement units;
means for displaying one or more forms to the user; and
means for modifying the content of the forms to display data associated with one or more phasor measurement units;

6. The computer program product of claim 5 further comprising means for configuring one or more of said forms.

7. The computer program product of claim 5 further comprising means to display pre-configured visualization within said forms.

8. The computer program product of claim 5 further comprising means for storing said data.

9. The computer program product of claim 8 further comprising means for receiving trigger bits such that the computer program product activates the means for storing data based on preprogrammed alarms.

10. A method of displaying a plurality of visualizations regarding phasor measurement units and synchronized phasors comprising the steps of:
displaying a first main form to a user;
receiving input from a user indicating that said main form is to be divided into sub-forms;
dividing said first main form into one or more sub-forms;
displaying a pre-configured visualization in one or more of the sub-forms, said visualization depicting data associated with phasor measurement units.

11. The method of claim 10 further comprising the steps of:
displaying a second main form on display device distinct from the device displaying the first main form;
receiving input from a user indicating that said second main form is to be divided into sub-forms; and
dividing said second main form into one or more subforms.

12. The method of claim 10 further comprising the steps of:
receiving input from a user indicating that one of said sub-forms is to be divided in to additional sub-forms; and
dividing said sub-form into one or more additional sub-forms.

13. The method of claim 10 further comprising the step of:
receiving data associated with phasor measurement units via a communications connection.

14. The method of claim 13 further comprising the step of:
recording said data associated with phasor measurement units on a computer system which also includes software for displaying visualizations of said data.

15. A method of visualizing real-time synchronized power system quantities using a configurable visualization tool comprising the steps of:
communicating time-aligned power system quantities to a computing system;
processing the time-aligned system quantities;
creating one or more docking windows on a first visual display; and
displaying a representation of the time aligned power system quantities.

16. The method of claim 15, further comprising the steps of:
sampling time aligned power system quantities from on or more intelligent electronic devices.

17. The method of claim 16, wherein the intelligent electronic devices are select from the group consisting of a phasor data concentrator, a phase measurement unit, and an integrated phasor data concentrator and phase measurement unit device.

18. The method of claim 15, further comprising the step of:
configuring one or more of the docking windows.

19. The method of claim 18, the step of configuring one or more of the docking windows includes configuring nested docking windows.

20. The method of claim 18, further comprising the step of:
creating a docking windows on a second visual display which is independent from the first visual display.

21. A method for transmitting synchronized phasors over a wide area network, comprising the steps of:
measurement power system data;
time-correlating the power system data;
aggregating the time-correlated power system data into aggregate data;
transferring the aggregated time-correlated power system to a computer system, said computer system having a display; and
utilizing configurable visualization software to display visualizations representing the aggregate data.
